(19) United States
(12) Patent Application Publication
(10) Pub. No.: US 2005/0070365 A1
(43) Pub. Date: Mar. 31, 2005

(54) Bushing for telescoping steering column assembly

(76) Inventors: Richard K. Riefe, Saginaw, MI (US); David M. Byers, Saginaw, MI (US); Christopher L. Walsh, Bay City, MI (US); Jeffrey J. Toth, Auburn, MI (US); Jesse Kalkman, Saginaw, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/674,541

(22) Filed: Sep. 30, 2003

(51) Int. Cl. F16C 3/03

(52) U.S. Cl. 464/162

(57) ABSTRACT

A telescoping steering column assembly includes lower and upper jackets having inner and outer surfaces, respectively, disposed with respect to one another in telescoping relationship. The telescoping steering column assembly includes a linear bushing disposed between the inner surface of the upper jacket and the outer surface of the lower jacket, that includes a plurality of convolutions disposed axially in side-by-side relationship as viewed in cross-section to provide outer and inner load bearing surfaces to engage the upper and lower jackets and to provide radial walls for flexing to maintain the bearing surfaces in engagement with the jackets to allow the bushing to radially expand and contract. The present invention provides the length-wise grooves formed by the convolutions to allow for reservoirs for lubricant solution to help reduce friction between the jackets, wherein the convolutions are elastically deformed to adapt to the annual clearance between the jackets.

### BACKGROUND OF THE INVENTION

1. Field of the Invention

The subject invention relates to a vehicle steering column of the kind having jackets of the column engaged one within the other in a telescoping fashion to adjust a height position of a steering wheel connected to the vehicle steering column to accommodate the position of a driver.

2. Description of the Prior Art

Generally, a variety of tilting and telescoping steering column arrangements have been developed and are used today in the field of automotive industry. A telescoping steering column assembly typically uses two jackets, wherein one jacket is fixed to a frame of a vehicle body, and the other jacket is adapted to be translated with respect to the jacket fixed to the frame, thereby providing relative longitudinal movement between the two jackets with respect to one another. These jackets, engaged one within another in a telescoping fashion, allow the driver to push or pull the steering wheel to a desired position and then to lock the telescoping column. Three fundamental conditions are required by the telescoping adjustment: the telescoping steering column must have a low adjustment force, the jackets must lock securely, and the stiffness of the telescoping steering column must not be degraded.

Various configurations and designs are available in the prior art for adjusting telescoping steering column assemblies and have been disclosed in U.S. Pat. Nos. 4,796,481 to Nolte, 5,287,763 to Nagashima, 5,520,416 to Singer, III et al., 5,921,577 to Weiss et al., 6,036,228 to Olgren et al., 6,216,552 to Friedewald et al., 6,364,357 to Jurik et al., 6,450,532 to Ryne et al., 6,540,618 to Mac Donald et al., and 6,543,807 to Fujiu et al. To provide the low adjustment force and high stiffness, the prior art designs include a sleeve bushing disposed between the jackets disposed one within the other in the telescoping fashion with a low coefficient of friction and a very close fit to the ID, i.e inner diameter, and OD, i.e. outer diameter, of the jackets. These two requirements are sometimes at odds, because the close fit may increase the adjustment force.

Although the prior art configurations of the telescoping steering column assembly are used in the automotive industry today, there remains an opportunity for a new design for adjusting the relative longitudinal position between two jackets of a steering column and for a telescoping sleeve that optimizes the performance in both areas.

### BRIEF SUMMARY OF INVENTION

A telescoping steering column assembly of the present invention includes a lower mounting mechanism for connecting to a body, a lower jacket having inner and outer surfaces connected to the lower mounting mechanism, an upper jacket having inner and outer surfaces and disposed in telescoping relationship with the lower jacket, and an upper mounting mechanism for connecting to the body for slidably supporting the upper jacket for telescoping movement relative to the lower jacket between various positions. The telescoping steering column assembly includes a linear bushing having leading and trailing ends and sidewall disposed between the inner surface of the upper jacket and the outer surface of the lower jacket. The linear bushing includes a plurality of convolutions disposed axially in side-by-side relationship as viewed in cross-section and extending between the ends of the bushing to provide outer load bearing surfaces to engage the inner surface of the upper jacket and to provide inner load bearing surfaces to engage the outer surface of the lower jacket and to provide radial walls for flexing to maintain the bearing surfaces in engagement with the jackets to allow the bushing to radially expand and contract.

An advantage of the present invention is to provide for inner and outer load bearings formed by convolutions to define reservoirs for a lubricant to help reduce friction between the upper and lower jackets, wherein the convolutions are elastically deformed to adapt to the annual clearance between the upper and lower jackets.

Another advantage of the present invention is to provide for an economical and positive improving of the telescoping effect. Still another advantage of the present invention is to provide for the linear bushing to function as spring elements to radially expand and contract in different modes of operation of the telescoping steering column assembly.

Accordingly, the telescoping steering column assembly having the linear bushing of the present invention is new, efficient, and provides for the linear bushing formed with a number of end-wise convolutions that each function as spring elements as well as load bearing surfaces to support the telescoping tubes and lubricate the upper and lower jackets engaged within one another in the telescoping fashion.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is an exploded perspective view of a telescoping steering column assembly having a linear bushing of the subject invention;

FIG. 2 is a perspective view of the linear bushing;

FIG. 3 is a perspective view of an alternative embodiment of the linear bushing shown in FIG. 2;

FIG. 4 is a cross sectional view of the telescoping steering column assembly having an upper jacket disposed in telescoping relationship within a lower jacket and the linear bushing disposed between the upper and lower jackets; and

FIG. 5 is a cross section view similar to FIG. 4 but showing the alternative embodiment of FIG. 3.

### DETAILED DESCRIPTION OF THE INVENTION

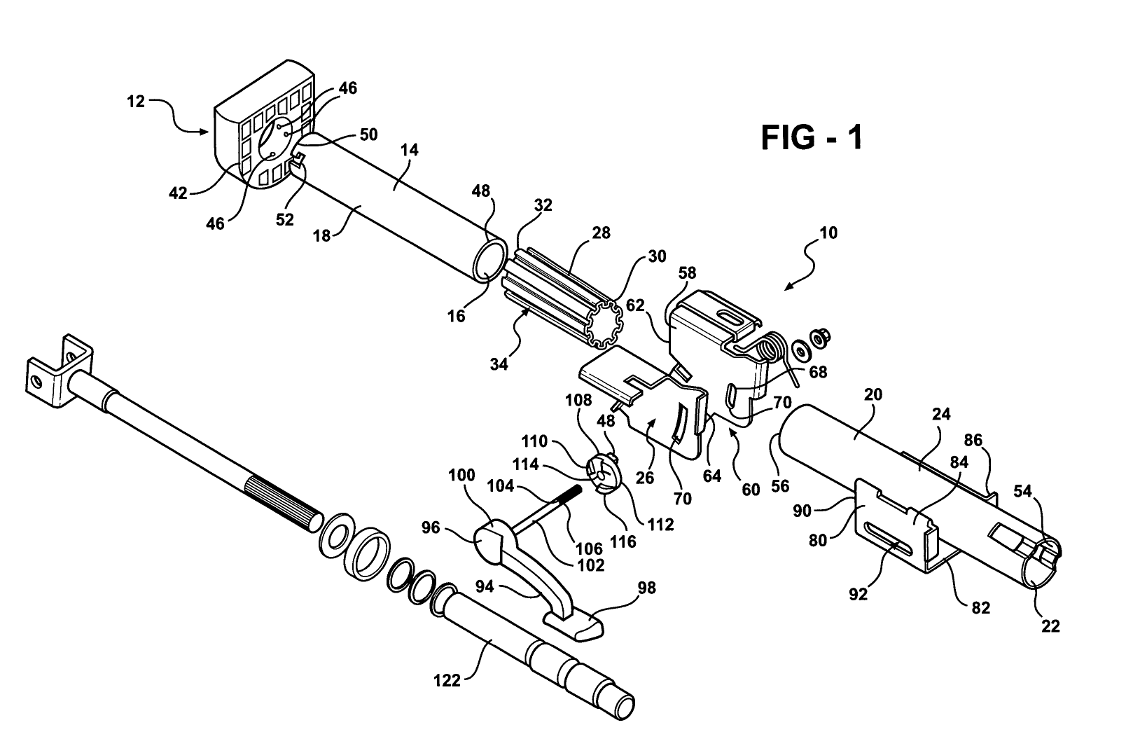

Referring to the Figures wherein like numerals indicate like or corresponding parts throughout the several views, a telescoping steering column assembly of the present invention, generally shown at 10 in FIG. 1. The assembly 10 includes a lower mounting mechanism is generally indicated at 12, for connecting to a body, and connected to a lower jacket 14 having inner 16 and outer 18 surfaces. An upper jacket 20 having inner 22 and outer 24 surfaces is disposed in telescoping relationship with the lower jacket 14, and an upper mounting mechanism for connecting to a vehicle body, is generally indicated at 26, and slidably supports the upper jacket 20 for telescoping movement relative to the lower jacket 14 between various positions.

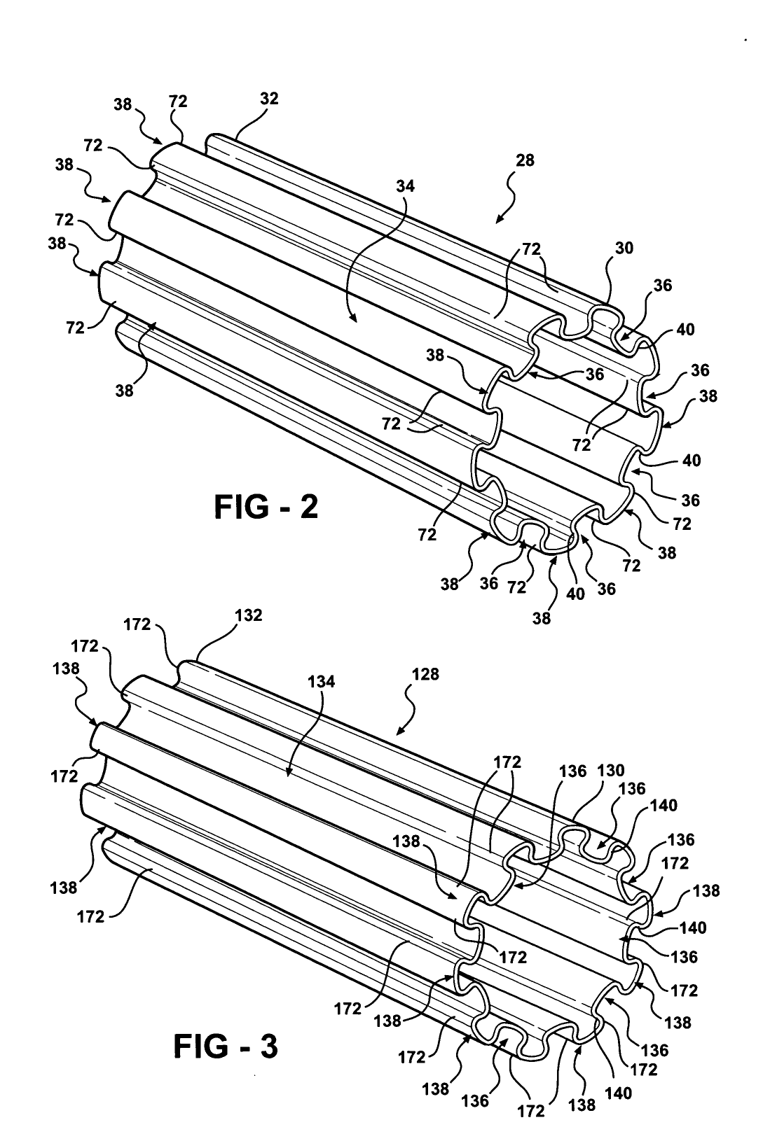

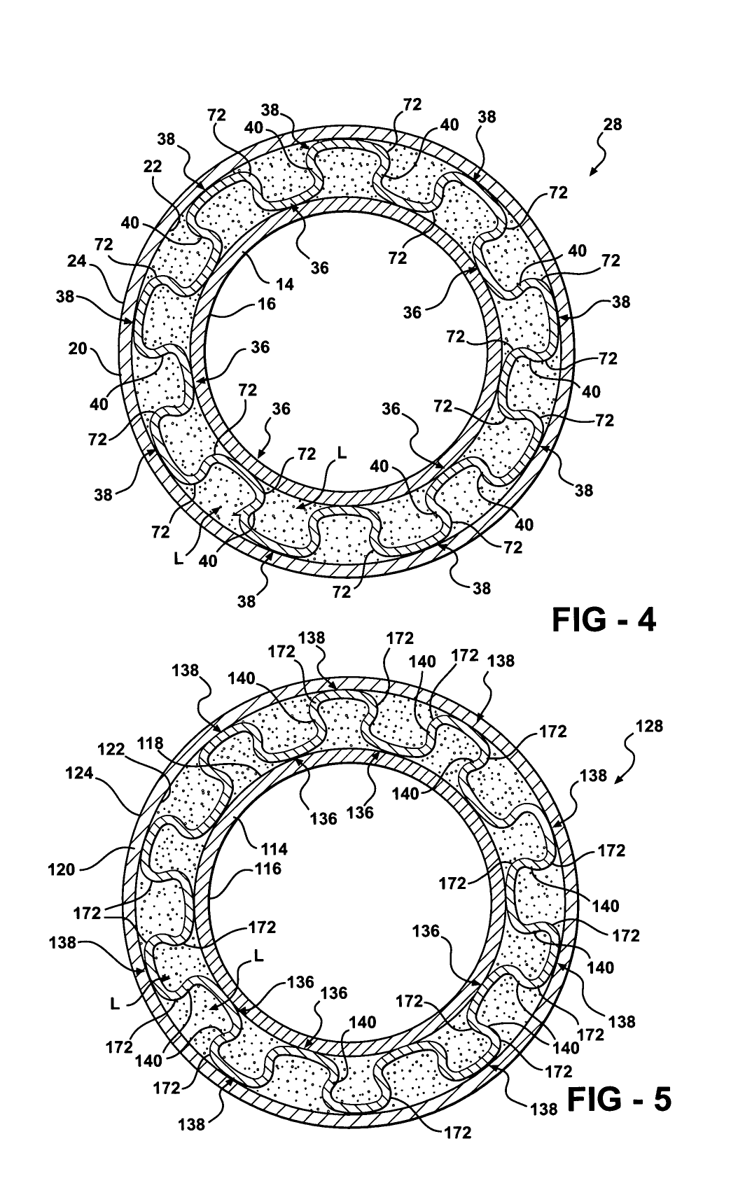

The telescoping steering column assembly 10 includes a linear bushing, generally shown at 28 in FIGS. 2 and 4, and at 128 in FIGS. 3 and 5, having leading 30, 130 and trailing 32,132 ends and a side wall, generally indicated at 34, 134, disposed between the inner surface 22 of the upper jacket 20 and the outer surface 18 of the lower jacket 14. The linear bushing 28, 128 includes a plurality of convolutions disposed axially in side-by-side relationship as viewed in cross-section, as shown in FIGS. 4 and 5, extending between the ends 30, 130 and 32, 132 of the linear bushing 28, 128 to provide outer load bearing surfaces, generally indicated at 36, 136 to engage the inner surface 22 of the upper jacket 20 and to provide inner load bearing surfaces, generally indicated at 38, 138 to engage the outer surface 18 of the lower jacket 14. The bushing 28, 128 also includes radial walls 40, 140 for flexing to maintain the bearing surfaces 36, 136 and 38, 138 in engagement with the jackets 14, 20 to allow the bushing 28, 128 to radially expand and contract.

Referring back to FIG. 1, the lower mounting mechanism 12 includes a lower bracket 42 of a generally rectangular configuration having an aperture 44 defined therewithin and a plurality of teeth 46 integral with and extending radially and outwardly from the lower bracket 42 to the aperture 44. The lower jacket 14 includes a generally tubular configuration and has leading 48 and trailing 50 ends a pair of waste portions 52 defined at the trailing end 50 to engage mechanically within the teeth 46 of the lower bracket 42. The upper jacket 20 includes a generally tubular configuration and has leading 54 and trailing 56 ends, wherein the upper jacket 20 is disposed in telescoping relationship with the lower jacket 14.

The upper mounting mechanism 26 of the telescoping steering column assembly 10 is designed to slidably support the upper jacket 20 for telescoping movement relative to the lower jacket 14 between various positions. The upper mounting mechanism 26 includes an upper bracket 58 having first 60 and second 62 ends, a bottom 64, and sides 66, 68 extending upwardly from the bottom 64 to define a gap therebetween. The upper bracket 58 includes a slot 70 defined within each of the sides 66, 68 at the first end 60.

Referring to FIGS. 2 through 5, the radial walls 40, 140 of the linear bushing 28, 128 converge toward one another from the outer 36, 136 and inner 38, 138 load bearing surfaces to define an opening opposite each load bearing surface as viewed in cross-section. The linear bushing 28, 128 includes a plurality of arcuate corners 72, 172 interconnecting the radial walls 40, 140 and the outer 36, 136 and inner 38, 138 load bearing surfaces as viewed in cross-section. In the embodiment of FIGS. 2 and 4, each of the inner load bearing surfaces 38 extends circumferentially a shorter distance than each of the outer load bearing surfaces 36 extends circumferentially. In the embodiment of FIGS. 3 and 5, each of the inner load bearing surfaces 136 extends circumferentially a longer distance than each of the outer load bearing surfaces 138 extends circumferentially.

Referring back to FIGS. 4 and 5, the linear bushing 28, 128 includes a lubricant L stored in the plurality of convolutions to dispose the lubricant L over the inner surface 22 of the upper jacket 20 and the outer surface 18 of the lower jacket 12 to help reduce friction between the lower 14 and upper 20 jackets. The linear bushing 28, 128 is formed by a plastic extrusion process to allow a variety of convolution shapes with the number of convolutions to meet the needs of the telescoping steering column assembly 10. The convolutions providing the outer 36, 136 and inner 38, 138 load bearing surfaces elastically deform radially to adapt the annular clearance between the lower 14 and upper 20 jackets. This deformation results in a zero clearance fit between the lower 14 and upper 20 jackets disposed in the telescoping relationship, and also results in an overlapping joint that is very stiff to resist bending.

The linear bushing 28, 128 may be manufactured in a form of a wrapped spring steel part or as a rolled convoluted tube. As appreciated by those skilled in the art, the linear bushing 28, 128 may be formed by an aluminum extrusion, or any other material or forming process to generate the convoluted shape with the proper springing effect. In addition, the lower 14 and upper 20 jackets, formed from metal, are coated with anti-friction material such as Teflon to promote lubricity. Furthermore, the linear bushing 28, 128 may be formed with a textured surface of a fine dimpled condition to retain other lubricants L such as grease, and the like.

Referring back to FIG. 1, the telescoping steering column assembly 10 includes a compression bracket 80 having a bottom 82 and side walls 84, 86 and first 88 and second 90 ends and an inlet 92 defined within the side walls 84, 86 and extending between the first 88 and second 90 ends of the compression bracket 80 perpendicularly to the slots 70 of the upper bracket 58. The compression bracket 80 is slidably disposed within the upper bracket 58. The telescoping steering column assembly 10 includes a release lever 94 having a shoulder 96 at one terminal end and a plate 98 at another terminal end. The shoulder 96 includes an inner surface 100 and a rod 102 extending outwardly therefrom to a distal end 104 having a male thread 106. In operation, the release lever 94, pushed upwardly or downwardly in different mode of operation controls the movement of the compression bracket 80 within the upper bracket 58.

The telescoping steering column assembly 10 includes an adjustment cam 108 of a generally circular configuration having upper 110 and lower 112 surfaces and a hole 114 defined in a center of the adjustment cam 108. The upper surface 110 of the adjustment cam 108 has a rake configuration 116 and a protrusion 118 extending outwardly from the lower surface 112. The rod 102 extends through the hole 114 of the adjustment cam 108 and further through the slots 70 of the upper bracket 58 and the inlets 92 of the compression bracket 80 and secured by a flange nut 120. The telescoping steering column assembly 10 includes a shaft 122 extending linearly and transversely through the upper 20 and lower 14 jackets.

Obviously, many modifications and variations of the present invention are possible in light of the above teachings. The invention may be practiced otherwise than as specifically described within the scope of the appended claims. These antecedent recitations should be interpreted to cover any combination in which the incentive novelty exercises its utility.

1. A telescoping steering column assembly comprising:
a lower mounting mechanism for connecting to a body,
a lower jacket having inner and outer surfaces connected to said lower mounting mechanism;
an upper jacket having inner and outer surfaces and disposed in telescoping relationship with said lower jacket,
an upper mounting mechanism for connecting to the body for slidably supporting said upper jacket for telescoping movement relative to said lower jacket between various positions,
a linear bushing having leading and trailing ends and side wall disposed between said inner surface of said upper jacket and said outer surface of said lower jacket, and
said linear bushing including a plurality of convolutions disposed axially in side-by-side relationship as viewed in cross-section and extending between said ends of said bushing to provide outer load bearing surfaces to engage said inner surface of said upper jacket and to provide inner load bearing surfaces to engage said outer surface of said lower jacket and to provide radial walls for flexing to maintain said bearing surfaces in engagement with said jackets to allow said bushing to radially expand and contract.

2. A telescoping steering column assembly as set forth in claim 1 wherein said radial walls converge toward one another from said inner and outer load bearing surfaces to define an opening opposite each load bearing surface as viewed in cross-section.

3. A telescoping steering column assembly as set forth in claim 2 including arcuate corners interconnecting said radial walls and said load bearing surfaces as viewed in cross-section.

4. A telescoping steering column assembly as set forth in claim 3 wherein each of said inner load bearing surfaces extends circumferentially a shorter distance than each of said outer load bearing surfaces extending circumferentially.

5. A telescoping steering column assembly as set forth in claim 3 wherein each of said inner load bearing surfaces extends circumferentially a longer distance than each of said outer load bearing surfaces extending circumferentially.

6. A telescoping steering column assembly as set forth in claim 1 including a lubricant in said plurality of convolutions to dispose the lubricant over said inner surface of said upper jacket and said outer surface of said lower jacket.

7. A telescoping steering column assembly as set forth in claim 3 wherein said lower mounting mechanism includes a lower bracket of a generally rectangular configuration having an aperture defined therewithin and a plurality of teeth integral with and extending radially and outwardly from said lower mounting bracket to said aperture.

8. A telescoping steering column assembly as set forth in claim 7 wherein said upper mounting mechanism includes an upper bracket having first and second ends and a bottom and sides extending upwardly from said bottom to define a gap therebetween.

9. A telescoping steering column assembly as set forth in claim 8 wherein said upper bracket includes a slot defined within each of said sides at said first end.

10. A telescoping steering column assembly as set forth in claim 9 including a compression bracket having a bottom and side walls and first and second ends and an inlet defined within said side walls and extending between said first and second ends of said compression bracket perpendicularly to said slots of said upper mounting bracket.

11. A telescoping steering column assembly as set forth in claim 10 wherein said compression bracket being slidably disposed within said upper mounting bracket.

12. A telescoping steering column assembly as set forth in claim 11 wherein said lower jacket includes a generally tubular configuration having leading and trailing ends and having a pair of waste portions defined at said trailing end to engage mechanically within said teeth of said lower mounting bracket.

13. A telescoping steering column assembly as set forth in claim 12 wherein said upper jacket includes a generally tubular configuration having leading and trailing ends and being disposed within said compression bracket.

14. A telescoping steering column assembly comprising:
a lower mounting mechanism for connecting to a body having a lower bracket of a generally rectangular configuration including an aperture defined therewithin and a plurality of teeth integral with and extending radially and outwardly from said lower bracket to said aperture;
a lower jacket of a generally tubular configuration having leading and trailing ends having inner and outer surfaces and having a pair of waste portions defined at said trailing end to engage mechanically within said teeth of said lower bracket;
an upper jacket of a generally tubular configuration having leading and trailing ends and having inner and outer surfaces and disposed in telescoping relationship with said lower jacket;
an upper mounting mechanism for connecting to the body for slidably supporting said upper jacket for telescoping movement relative to said lower jacket between various positions wherein said upper mounting mechanism includes an upper bracket having first and second ends and a bottom and sides extending upwardly from said bottom to define a gap therebetween;
said upper bracket including a slot defined within each of said sides at said first end;
a linear bushing having leading and trailing ends and side wall disposed between said inner surface of said upper jacket and said outer surface of said lower jacket;
said linear bushing including a plurality of convolutions disposed axially in side-by-side relationship as viewed in cross-section and extending between said ends of said bushing to provide outer load bearing surfaces to engage said inner surface of said upper jacket and to provide inner load bearing surfaces to engage said outer surface of said lower jacket and to provide radial walls for flexing to maintain said bearing surfaces in engagement with said jackets to allow said bushing to radially expand and contract;
said radial walls converge toward one another from said inner and outer load bearing surfaces to define an opening opposite each load bearing surface as viewed in cross-section;
a plurality of arcuate comers interconnecting said radial walls and said inner and outer load bearing surfaces as viewed in cross-section wherein each of said inner load bearing surfaces extends circumferentially a shorter distance than each of said outer load bearing surfaces extends circumferentially and each of said inner load bearing surfaces extends circumferentially a longer distance than each of said outer load bearing surfaces extends circumferentially;
a lubricant stored in said plurality of convolutions to dispose the lubricant over said inner surface of said upper jacket and said outer surface of said lower jacket;
a compression bracket having a bottom and side walls and first and second ends and an inlet defined within said side walls and extending between said first and second ends of said compression bracket perpendicularly to said slots of said upper mounting bracket; and
said compression bracket being slidably disposed within said upper mounting bracket.
